(19) United States
(12) Patent Application Publication
(10) Pub. No.: US 2006/0193444 A1
(43) Pub. Date: Aug. 31, 2006

(54) Line testing apparatus and method

(76) Inventors: David Aufenast, Bawdsey (GB); Mark A. Fletcher, Ipswich (GB); Michael D. Hoy, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/550,206

(22) PCT Filed: Mar. 26, 2004
(86) PCT No.: PCT/GB04/01340

§ 371 Date: Sep. 21, 2005

(30) Foreign Application Priority Data
Mar. 27, 2003 (GB) 0307115.6

(51) Int. Cl. H04M 1/24; H04M 3/08

(52) U.S. Cl. 379/22; 379/1.01

(57) ABSTRACT

The line test apparatus includes a PC (5) which stores known line test signature parameters for a number of known fault conditions in which by application of varying signals to a line pair (2,3) under test and capturing parameters during a period in which varying signals are applied to the line via a test head (1), an estimate of the state of the line can be made. A remote unit (6) located at a switch or exchange may also be used to complete the automated scanning of parameters of a line in response to various electrical stimuli. The invention is particularly effective at determining faults which are “dynamic” as well as those which are permanent until repaired.

The present invention relates to a line testing method and apparatus using such a method.

Telecommunications networks, and more specifically the so-called local loop, comprise large numbers of pairs of metallic conductors insulated from each other by plastics, ceramic or fibre based materials. Faults may arise in the network due to the breakdown of the insulating material resulting in cross coupling between the conductors of a pair or in cross coupling between one or more pairs of conductors.

When a permanent breakdown occurs it is relatively easy to detect since measurement of resistance, capacitance, inductance and conductance in known manner enables the fault to be identified while pulsed echo techniques enable the location of the fault to be found within a few metres.

Dynamic faults are more difficult to identify particularly where they result in breakdowns of short duration under specified conditions. For example, the assignee of the present invention has disclosed a method of identifying the presence of charge affecting faults arising from one kind of dynamic fault in which the application of ringing current to operate alert mechanisms at customers premises causes a breakdown which appears to the switch equipment to be a call answer condition. Removal of the ringing current in response to the call answer condition causes an apparent call clear condition giving a very short holding time call. Examining the records of short holding time calls it is possible to identify potentially faulty lines where several calls to the same network customer exhibit short holding time characteristics regardless of the origin of the call.

In practice BT, the United Kingdom's major network operator, has identified that lines identified using the method disclosed in our published PCT patent application no WO02/13497 become customer reported faulty lines within two months of initial identification in forty eight percent of cases where pre-emptive remedial action is not taken.

Apart from faults such as those resulting in ring trip events, dynamic faults indicative of a potential line failure can manifest to the customer as noisy or attenuated lines affecting the customer's overall perception of the quality of service and potentially resulting in poor performance of computer apparatus for example where slow running may result from requirements for data re-transmission due to bit error faults.

Although certain identified potentially faulty lines may be confirmed by traditional line testing equipment at the switch or in the field, many lines do not exhibit fault characteristics when tested in the traditional manner.

In U.S. Pat. No. 5,937,033 there is disclosed a testing apparatus which is permanently connected to perform tests on each of a plurality of drop wire circuits at approximately one hour intervals. Various static parameters of the drop wire are determined and transmitted to a test analyser which compares the respective measurements for each line with previous measurements for the same line thus enabling deterioration of a drop wire line over time to be recognised and remedial action to be taken.

U.S. Pat. No. 5,699,402 discloses a similar arrangement in which operating parameters of a line are stored at a time when the line is thought to be fault free. Re-testing of the same line when a fault is reported enables comparison of “good” and current parameters for the same line to be used to determine the location of the fault reported.

According to the present invention there is provided a method of testing communications lines comprising the steps of connecting parameter measuring apparatus across at least two conducting wires, applying a voltage across said conducting wires, varying said voltage or current derived there from with time in accordance with a predetermined pattern, measuring parameters at intervals over a period of time and recording the parameter values, and comparing said parameter value variation over time with one or more known patterns of parameter value variation to determine status of the communications line under test.

The test patterns may include line signatures derived from parameters including positive, negative and reverse polarity tests between the a and b legs of a conducting pair and between each of the a leg and the b leg and earth. Accordingly up to six potential line signatures may be measured during the test time interval which may be compared with stored patterns derived from previously tested lines exhibiting fault characteristics or derived hypothetically.

According to a feature of the present invention there is provided line test apparatus comprising processing means operating in accordance with the invention and having at least two connections for coupling parameter measuring devices to one or more metallic paths of a conducting pair and/or an earth connection, storage means for recording parameter measurement over a period of time and means to control the application of electrical stimuli during said period of time whereby line signatures of a metallic pair may be obtained for comparison with one or more stored patterns of parameter values.

The line test apparatus may comprise a single unit including processing capability or may comprise a plurality of units at least one of which includes means to apply the electrical stimuli and means for coupling parameter measuring devices, the other including means to process line signatures of a metallic pair under test. The two units may comprise a test head and a processor unit respectively, the two units communicating by low power radio or infra red coupling. Alternatively, the test head may include means to capture and store line signatures for subsequent transfer to and analysis by the processing unit.

A tester and method of testing in accordance with the invention will now be described by way of example only with reference to the accompanying drawings of which:

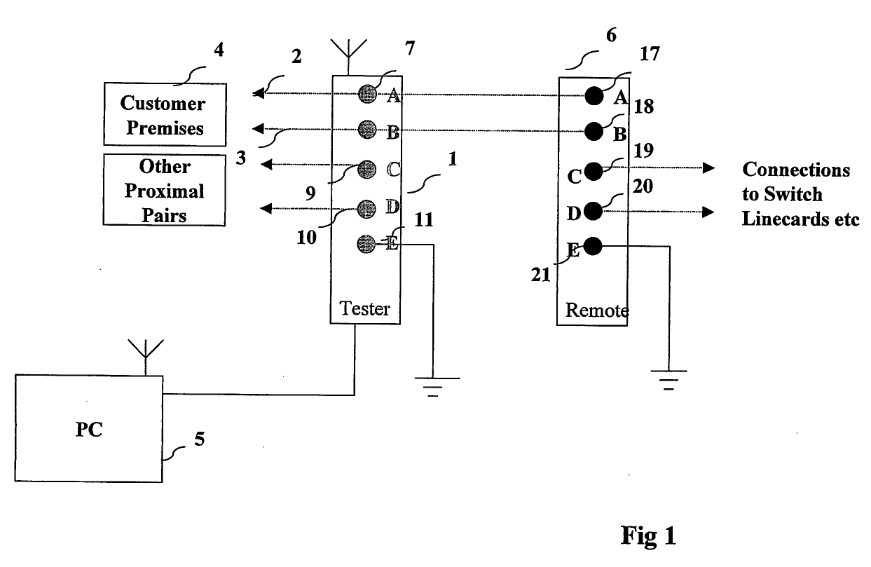

FIG. 1 is a block schematic diagram of the tester set-up;

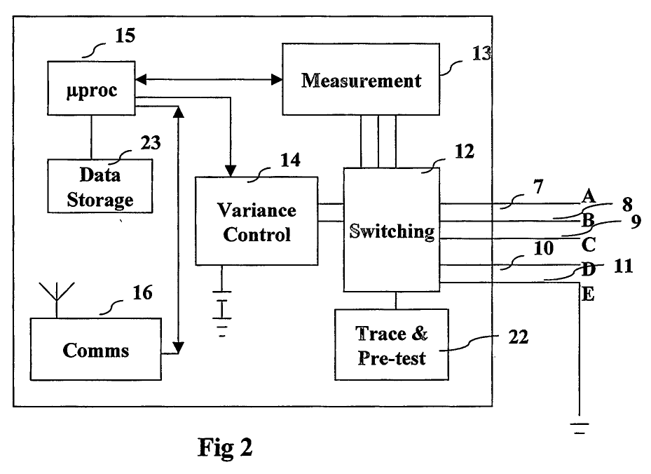

FIG. 2 is a block schematic diagram of one part of the tester of FIG. 1;

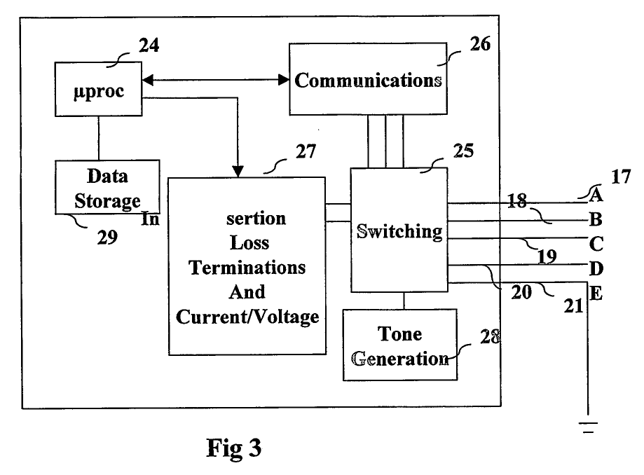

FIG. 3 is a block schematic diagram of a second part of the tester of FIG. 1;

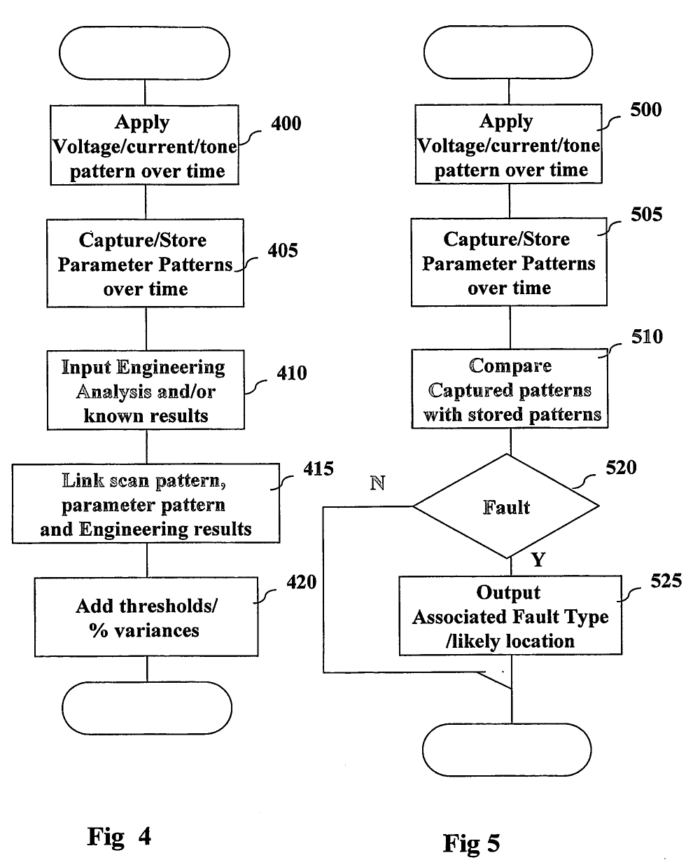

FIG. 4 is a flow chart showing the operation of the part of the tester shown in FIG. 2; and

FIG. 5 is a flow chart showing the operation of a third part of the tester of FIG. 1.

Referring first to FIG. 1, the tester comprises three parts which co-operate to perform a complete test but each of which may function individually to complete testing of a communications line. The first part 1 is a portable test head arranged for connection to a customer line pair 2,3 at or near to customer premises 4.

The portable test head 1 communicates with the second part which comprises a computer 5 which is preferably a laptop computer, for example a National Panasonic “Toughbook” laptop computer, which is pre-programmed to analyse the results of testing in the manner hereinafter described.

The third part resides at a telephone exchange or switch or may be located at a distribution cabinet between the customer line and the exchange, and comprises a remote unit 6 which may be controllable by signalling from the test head 1 either over the pair under test or over another circuit.

In operation test probes or clips of the test head 1 are attached to or applied to the customer line ‘A’ leg and ‘B’ leg 2,3 from terminals 7,8. The test head may work in stand alone mode in which case under microprocessor control voltage and/or controlled current may be applied to the customer line and parameter readings of leakage, capacitance and resistance parameters may be made. The operation of the test head is explained in more detail hereinafter. During testing terminals 9 and 10 (‘C’ and ‘D’) may be used to enable signals to be applied and measurements made from adjacent lines while terminal 11 (‘E’) is connected to earth. This arrangement allows measurements between the customer line A leg and Earth and the customer line B leg and earth to be undertaken and also permits the measurement of parameters between the line 2,3 and other lines at the pole top or in cross connection cabinets and manholes for example.

The remote unit 6 has corresponding terminals A to E (17-21) the terminals 17, 18 being connected to the customer line A and B legs at the switch or at a distribution frame of the exchange and the terminal 21 (‘E’) is again coupled to earth. This connection arrangement allows further measurements to be undertaken from the remote end and by applying tones to the terminals 17, 18 allows the user of the test head 1 to listen or otherwise search for the correct pair to be tested. Parameter measurements thus undertaken from both the remote tester 6 and the test head 1 permits the location of a potential fault to be more closely estimated and also allows voltages and currents to be applied at the switch and parameters measurement to occur at the test head 6 or vice versa.

For the avoidance of doubt it should be noted that while the terminals in both units 1 and 6 are referenced as being connected to line pairs and the like they may be connected in series with the line whereby switching in and out of line segments may be carried out and/or connection of the customer line back to line cards and other switch connections may occur. Such activity again promotes the identification of the location of a fault or enables the isolation of a faulty segment of customer line so that further tests may be carried out.

Note that when the test head 1 is in stand-alone use, with or without the remote unit 6 a data store is used to capture the parameter readings over time for subsequent analysis of potential faults. In this case the stored parameters may be down loaded to the PC 5 or to another PC for analysis should the user not find the result apparent from the test head 1 itself.

In an alternative mode of operation the test head 1 may be used under the control of or in association with the PC 5 so that more immediate analysis of the results may be obtained and/or so that the PC 5 may determine from concurrent analysis what further testing should be carried out. It will be noted that the PC 5 may be directly connected to the test head 1 although each could be equipped with a suitable low power radio communication arrangement such as that known as “bluetooth”. In either event communication between terminals and PC's is a well established art which requires no further description herein.

Turning now to FIG. 2, the test head 1 is shown in greater detail in schematic form. Again the terminals A-E, 7-11 are shown connected to a switching unit 12 which by electronic or electromechanical switching permits application of the voltage and current signals to the A and B legs and/or to adjacent pair terminals 9 and 10 so that measurement can be carried out. Similarly the switching unit may switch measuring devices as appropriate (represented by the measurement unit 13) in to and out of coupling with the terminals in various ways. While the terms voltage signals and current signals are used herein it will be apparent that these signals may vary over time and may be for example sinusoidal, non-sinusoidal or mixed frequency signals representative of signalling normally present on line pairs or otherwise to enable the testing of line reaction to such signal variations. The signals applied are generated by a variance control 14 under the control of a microprocessor 15 which may itself be under the control of the PC 5 (of FIG. 1). Connection between the test head 1 and the PC 5 is shown here as by low power radio communication through a communications unit 16.

It will also be noted that the microprocessor 15 also controls the switching in and out of the various combinations of line connections through the switching unit 12 along with the selection of the parameter measuring devices 13.

As previously mentioned, the test head 1 may work in association with a remote unit 6 of FIG. 1 and therefore includes tracing functionality to enable the identification of tones and other information transmitted from the switch or distribution frame. This may be by audio or other identification, for example a digital trace pattern could be transmitted which is output to audio or visual displays at the test head. This functionality is represented as trace and pre-test 22, the trace function enabling the identification of a specific pair to be tested for example.

The pre-test functionality is included for completeness and may be used to identify other signals and voltages present in the line under test for example checking for the presence of dangerous voltages, the presence of other signals, for example ADSL or similar signalling which might be adversely affected by the application of testing signals and other uses of the line to be tested. Only once these tests are carried out so that the safety of personnel using the apparatus and the avoidance of damage to the unit along with the avoidance of interference with live customer traffic does the primary testing commence.

Finally, within the test head 1 there is shown a data storage element 23 which is used to capture the results from the measurement devices 13 along with timing elements and reference data which may be entered by the operator or could be transmitted from the remote unit to the test head.

Referring now to FIG. 3 there is shown a schematic diagram of the remote unit 6 which is again controlled by a microprocessor 24 and incorporates a switching unit 25. The terminals 17, 18 are connected to the A and B legs of the customer line as hereinbefore mentioned the terminals 19 and 20 being connected back to the customer line card at the switch (not shown). Under control of the microprocessor the switching unit can be used to disconnect the customer line from the switch when required for testing although it is expected that normal customer line service eis maintained by having a through connection from the C and D terminals to the A nd B terminals except when the test head or PC causes signalling to be sent to the remote unit 6 to effect disconnection of the line from other equipment.

For this purpose a communications transceiver 26 is provided which is responsive to line signalling from the test head to communicate requirements to the microprocessor 24. The microprocessor 24 controls the other units, including the switching unit 25 for example to use a terminations unit 27 to apply a loop to the line or to supply resistive terminations across the terminals 17 and 18 by way of the switching unit 25.

Data storage 29 is also provided to enable test patterns and the like to be stored for use by the microprocessor 24 and/or to store the results parameter measurements which may be carried out at the remote tester under control of or in response to conditions applied at the test head 1.

Returning briefly to FIG. 1, in use, the PC 5 may be activated by the user to run through a test program controlling the test head1 and/or the remote unit 6 to apply conditions, connect and disconnect various through connections such as to the switch line cards or the customer premises and to capture the various measurable line conditions. Once communication is established between the test head 1 and the remote unit 6, possibly by the user searching for tones using a test probe connected the terminals 7 and 8, testing may be carried out. For this reason the PC 5 (and the microprocessor 15) includes a knowledge based analysis system derived from scanning previously known faulty line pairs. Thus by applying a pre-determined pattern of tones, voltages and currents to the line pair with or without terminations, line loops and the like applied and measuring parameters between A and B legs at the switch and/or at the pole top and between each of those legs and earth potentially also with the application of conditions to adjacent pairs and measurement of parameters related to those pairs, a comprehensive determination of potential faults can be carried out. In particular, line degradation which may develop in to a fault, or which will give rise to a fault in certain conditions such as after heavy rainfall, can be assessed by the knowledge base.

Referring then to FIG. 5, the PC 5 of FIG. 1 is first programmed using skilled personnel to develop a scan pattern which is applied (step 400) to a number of lines over a period of time. Some of these lines will be known faulty lines and the results of many hundreds of scans using differing test scan patterns (varying voltage/current/frequency with line loops/impedances, switch connection in and out and the like) and capturing parameters (step 405) of the tested lines such as capacitance, leakage resistance between the legs of the pair and between each leg and earth and such like.

Now where a series of test results are stored for line pairs which do not exhibit a fault but which subsequently become faulty in some way it is possible to review stored test patterns to check for deviation from the norm in respect of those lines so that the knowledge base of degradation occurring over time can be used to effect an engineering analysis.

Thus scan patterns and parameter patterns associated with those scan patterns can be stored and known faulty line details together with potential fault details from engineering analysis can be input to the PC5 (step 410) and the patterns and engineering analysis may be linked for subsequent use (step 415).

For each scan pattern developed over time it is possible to add thresholds (step 420) such as minimum and maximum line resistance at certain scan pattern times or percentage variances within which a scan pattern may vary so that when multiple test scans give similar results a minimalised set of patterns with variance parameters can be established.

All of these functions may be held in the PC 5 but only the Voltage/Current and Tone scan patterns need to be held in the microprocessor of the test head 1 since this will simply capture the parameter pattern for subsequent use by the PC 5. Note that the scan patterns will include, where appropriate, the instruction set for inserting impedances, line loops etc at the remote end (switch) so that a complete test can be carried out. Test patterns may be of any length from a few milliseconds of variation to a considerably longer test and may include instruction output for the engineer in applying test probes or connections in a differing manner at various test stages. Several test may be performed using differing scan patterns on any one pair so that several parameter scan results may be used for subsequent analysis.

Thus referring also to FIG. 5, when a line pair is under test, the test head, either independently or under control of the PC 5 by way of the communications link, applies one of the known test scan patterns (step 500) of varying voltage/current/frequency and communicates switching instructions to the remote unit at the switch so that controlled timing of the scanning pattern occurs. The test head will capture the parameters(step 505) as the scan progresses and will store the parameters as a linked set of results for the various combinations of parameter measurements using time linking to ensure that the conditions being input to the line can be compared with the resulting parameter scans.

The scanned pattern can be stored for subsequent downloading to the PC 5 and/or can be stored at the test head for subsequent downloading and comparison. Note also that the remote end unit at the switch may also be capturing test pattern results simultaneously so that comparative date linked to the applied scan pattern is available from that source also and may be incorporated in to the knowledge base for comparison.

Thus at step 510 the PC 5 can collate the captured patterns and carry out a comparison between the captured patterns and the stored patterns applying variances while looking for a match between know fault conditions. If no match is obtained between the captured parameters and a stored set (or the captured pattern falls within the variance from an acceptable pattern stored in respect of non-faulty lines) (step 520) then a simple output message of line ok may be provided. At the same time the scan result may be stored either in the PC 5 or transferred to a master database for future reference. It is here noted that the PC 5 may be periodically updated from the master database so that trends in parameter scanning from all tests carried out and resulting fault analysis can be used to update the process from time to time. Further scanning patterns may be developed and associated with parameter scan results so that constant improvement of the identity of faults (and degradation which may lead to a fault thus enabling pre-emptive repair), occurs.

Finally, where a test match to a fault pattern is obtained the PC 5 will output the result of the most likely fault and, where possible, its likely location.

The method and apparatus hereinbefore described is particularly useful for locating so-called dynamic faults which are responsive to particular line conditions to manifest. For example some faults which occur in response to the application of ringing current are difficult to locate but simulating conditions using a test pattern and monitoring the signatures of the line can detect such dynamic faults. Pulse responses can also be measured to provide appropriate signatures for comparison.

1. A method of testing communications lines comprising the steps of connecting parameter measuring apparatus across at least two conducting wires, applying a voltage across said conducting wires, varying said voltage or current derived there from with time in accordance with a predetermined pattern, measuring parameters at intervals over a period of time and recording the parameter values, and comparing said parameter value variation over time with one or more known patterns of parameter value variation to determine status of the communications line under test.

2. A method of testing communications lines as claimed in claim 1 in which the test patterns include line signatures derived from parameters including positive, negative and reverse polarity tests between the a and b legs of a conducting pair.

3. A method of testing communications lines as claimed in claim 1 in which the test patterns include line signatures derived from parameters including positive and negative polarity tests between each of the a leg and the b leg and earth.

4. A method of testing communications lines as claimed in claim 1 in which a plurality of line signatures are measured during the test time interval each of which is compared with stored patterns derived from previously tested lines exhibiting fault characteristics or derived hypothetically.

5. A line test apparatus comprising processing means operating in accordance with the method of claim 1 and having at least two connections for coupling parameter measuring devices to one or more metallic paths of a conducting pair and/or an earth connection, storage means for recording parameter measurement over a period of time and means to control the application of electrical stimuli during said period of time whereby line signatures of a metallic pair may be obtained for comparison with one or more stored patterns of parameter values.

6. Line test apparatus as claimed in claim 5 comprising a unit including processing capability for capturing and analysing line signatures.

7. Line test apparatus as claimed in claim 5 comprising a plurality of units at least one of which includes means to apply the electrical stimuli and means for coupling parameter measuring devices, the other including means to process line signatures of a metallic pair under test.

8. Line test apparatus as claimed in claim 7 in which the units comprise a test head and a processor unit respectively, each communicating with the other by low power radio or infra red coupling.

9. Line test apparatus as claimed in claim 7 in which the units comprise a test head and a processor unit respectively, each communicating with the other by direct coupling.

10. Line test apparatus as claimed in claim 8 in which the test head includes means to capture and store line signatures for subsequent transfer to and analysis by the processor unit.

11. Line test apparatus as claimed in claim 5 further comprising a remote unit operating under the control of the processor unit to apply test patterns and control the application of loop resistance values and/or current/voltage and/or frequency signals to a line under test.

12. Line test apparatus as claimed in claim 1 1 in which the apparatus comprises a or the test head and in which signalling to control the remote unit is transmitted from the test head to the remote unit under the control of the processor unit.
